(19) United States
(12) Patent Application Publication
(10) Pub. No.: US 2018/0238488 A1
(43) Pub. Date: Aug. 23, 2018

(54) Digital Reality Equipment Resting Stand

(71) Applicant: Tree Cloud LLC, Houston, TX (US)

(72) Inventor: Christopher Charles Dillon, Houston, TX (US)

(21) Appl. No.: 15/900,757

(22) Filed: Feb. 20, 2018

Related U.S. Application Data
(60) Provisional application No. 62/544,763, filed on Aug. 11, 2017.
(60) Provisional application No. 62/461,724, filed on Feb. 21, 2017.

(51) Int. Cl. F16M 11/38

(52) U.S. Cl. CPC F16M 11/38; H02J 7/0044

(57) ABSTRACT

Various implementations described herein are directed to a digital reality and/or computer-mediated reality resting stand. In one implementation, a digital reality and/or computer-mediated reality resting stand includes one or more platforms. In another implementation, a digital reality and/or computer-mediated reality resting stand includes an X-shaped configuration.

### CROSS-REFERENCE TO RELATED APPLICATIONS

This application claims the benefit of U.S. Provisional Application No. 62/461,724, filed Feb. 21, 2017, and U.S. Provisional Application No. 62/544,763, filed Aug. 11, 2017, all of which are incorporated herein by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Virtual reality (VR), augmented reality (AR), and mixed reality (MR) hand controllers, regardless of brand, typically have a 3-dimensional circular or somewhat rounded radius shaped ring design feature as part of the controller. The hand controller may be equipped with sensors surrounding portions of the controller for computer tracking purposes in space, and precise virtual placement and location of the controller when a user is engaged inside VR, AR, or MR. This category of hand controller, due to its designed shape and dimensions for proper function, tends to be awkward and unstable when placed at rest, sometimes rolling to one side or the other. Thus, the likelihood that the hand controller may fall and/or become damaged from falling off a table or a desk is relatively high. The headset or head-mounted display (HMD) is also oriented awkwardly due to the front end of the goggles or glasses being heavier with lenses and electronics and the backside being lighter with head straps. In addition, the earphones drop down at ear level, thus increasing instability in the front by creating a tilt towards the higher weighted front end of the headset when the headset is at rest on a surface. The likelihood that the headset may fall and/or become damaged from falling off a table or a desk is also relatively high.

### SUMMARY

Described herein are various implementations of a virtual reality equipment resting stand. In one implementation, the virtual reality equipment resting stand includes: a first platform configured to support at least a portion of the VR equipment, a second platform; and at least one vertical spacer coupling the first platform and the second platform.

A first end of the vertical spacer may be coupled to the first platform and a second end of the vertical spacer may be coupled to the second platform.

The first platform may include at least one opening to support at least the portion of the VR equipment. The first platform, the second platform, and the vertical spacer may be a single piece of continuous material. The single piece of continuous material may be molded or bent to form the first platform, the second platform and the vertical spacer.

The first platform may include a cut away configured to keep a proximity sensor of the VR equipment in a deactivated state.

In one implementation, the VR equipment resting stand can be configured to hold at least the portion of the VR equipment such that the VR equipment is level.

In one implementation, the first platform can be configured to hold at least the portion of the VR equipment such that the VR equipment is hovering above the second platform.

In one implementation, the first platform is configured to hold at least the portion of the VR equipment such that a second portion of the VR equipment is touching the second platform.

The first platform may include at least one cut away to accommodate embedded sensors, buttons and/or triggers of the VR equipment.

Described herein are various implementations of a virtual reality equipment resting stand. The resting stand includes a first piece having a first front portion and a first rear portion and a second piece having a second front portion and a second rear portion. The first piece and the second piece are shaped to interlock and form an X-shape. The first front portion and the second front portion are shaped to support at least a portion of the VR equipment.

The VR equipment resting stand may include a battery. The VR equipment resting stand may also include a charging port. The charging port can be used to charge a battery and/or VR equipment.

In one implementation, in a disengaged state, the first piece and the second piece are fastened together in a flat configuration. In one implementation, the first piece and the second piece are fastened together using magnets.

In one implementation, the VR equipment resting stand may include lighting.

Described herein are various implementations of a virtual reality equipment resting stand. The virtual reality equipment resting stand includes a front portion and a rear portion. The front portion and the rear portion are coupled together via a hinge. The front portion is shaped to support at least a portion of the VR equipment.

The VR equipment resting stand is configured to have a flat configuration in a closed state and an X-shaped configuration in an open state. In one implementation, at least one of the open state and the closed can be activated using a push button swivel mechanism.

The above referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a headset and hand controllers in accordance with implementations of various techniques described herein.

FIG. 2 illustrates a perspective view of a headset in accordance with implementations of various techniques described herein.

FIG. 3 illustrates a partial view of the optics and a rigid structure of a headset in accordance with implementations of various techniques described herein.

FIG. 4 illustrates a perspective view and a front view of a headset resting stand in accordance with implementations of various techniques described herein.

FIG. 5 illustrates platform top view and a side view of a headset resting stand in accordance with implementations of various techniques described herein.

FIG. 6 illustrates resting a headset on an elevated platform in accordance with implementations of various techniques described herein.

FIG. 7 illustrates a perspective view of a hand controller resting stand in accordance with implementations of various techniques described herein.

FIG. 8 illustrates two hand controllers being stored on a resting stand in accordance with implementations of various techniques described herein.

FIG. 9 illustrates a level aspect in accordance with implementations of various techniques described herein.

FIG. 10 illustrates a hovering aspect in accordance with implementations of various techniques described herein.

FIG. 11 illustrates a headset stand in accordance with implementations of various techniques described herein.

FIG. 12 illustrates a headset resting on the headset stand in accordance with implementations of various techniques described herein.

FIG. 13 illustrates a top portion of a headset stand having a cut away space in accordance with implementations of various techniques described herein.

FIG. 14 illustrates a proximity sensor of a headset in accordance with implementations of various techniques described herein.

FIG. 15 illustrates a proximity sensor of a headset in accordance with implementations of various techniques described herein.

FIG. 16 illustrates a headset stored on a resting stand in accordance with implementations of various techniques described herein.

FIG. 17 illustrates a hand controller stand in accordance with implementations of various techniques described herein.

FIG. 18 illustrates a hand controller stand having two hand controllers stored thereupon in accordance with implementations of various techniques described herein.

FIG. 19 illustrates an angle of a hand controller stand in accordance with implementations of various techniques described herein.

FIG. 20 illustrates a cut away of a hand controller stand in accordance with implementations of various techniques described herein.

FIG. 21 illustrates a perspective view of a resting stand for a headset in accordance with implementations of various techniques described herein.

FIG. 22 illustrates a headset resting on a resting stand in accordance with implementations of various techniques described herein.

FIG. 23 illustrates a headset resting on a resting stand in accordance with implementations of various techniques described herein.

FIG. 24 illustrates a resting stand shaped from a single strip of material in accordance with implementations of various techniques described herein.

FIG. 25 illustrates a hand controller resting stand in accordance with implementations of various techniques described herein.

FIG. 26 illustrates a base of a resting stand in the shape of an X configuration in accordance with implementations of various techniques described herein.

FIG. 27 illustrates a resting stand in an X configuration in accordance with implementations of various techniques described herein.

FIG. 28 illustrates an X-shaped stand in a disengaged state in accordance with implementations of various techniques described herein.

FIG. 29 illustrates the X-shaped stand in a collapsed position in accordance with implementations of various techniques described herein.

FIG. 30 illustrates the X-shaped stand having a cross brace in accordance with implementations of various techniques described herein.

FIG. 31 illustrates a hinged configuration of an X-shaped resting stand in accordance with implementations of various techniques described herein.

FIG. 32 illustrates the hinged configuration of the X-shaped resting stand in a collapsed position in accordance with implementations of various techniques described herein.

FIG. 33 illustrates a headset resting in an X-shaped resting stand in accordance with implementations of various techniques described herein.

FIG. 34 illustrates a wall-mounted configuration of an X-shaped stand in accordance with implementations of various techniques described herein.

FIG. 35 illustrates a wall-mounted configuration for a plurality of X-shaped stands in accordance with implementations of various techniques described herein.

FIG. 36 illustrates an interface for coupling an X-shaped stand to a wall in accordance with implementations of various techniques described herein.

FIG. 37 illustrates power interfaces for an X-shaped resting stand and a wall railing system in accordance with implementations of various techniques described herein.

FIG. 38 illustrates a double hinged configuration of an X-shaped resting stand in accordance with implementations of various techniques described herein.

FIG. 39 illustrates a floating bolt configuration for coupling a hand controller resting stand to a wall in accordance with implementations of various techniques described herein.

### DETAILED DESCRIPTION

The present disclosure describes inventive resting stands that keep digital reality and/or computer-mediated reality, e.g., Virtual Reality (VR), Augmented Reality (AR), Mixed Reality (MR), and/or holographic, equipment stored and at rest in a stable, organized and secured manner. The digital or computer-mediated reality equipment may include headsets, hand controllers, cameras, sensors, etc. Using the presently disclosed resting stands reduces the chances of damaging the VR, AR, MR and holographic equipment, and provides stability for the equipment when the equipment is at rest.

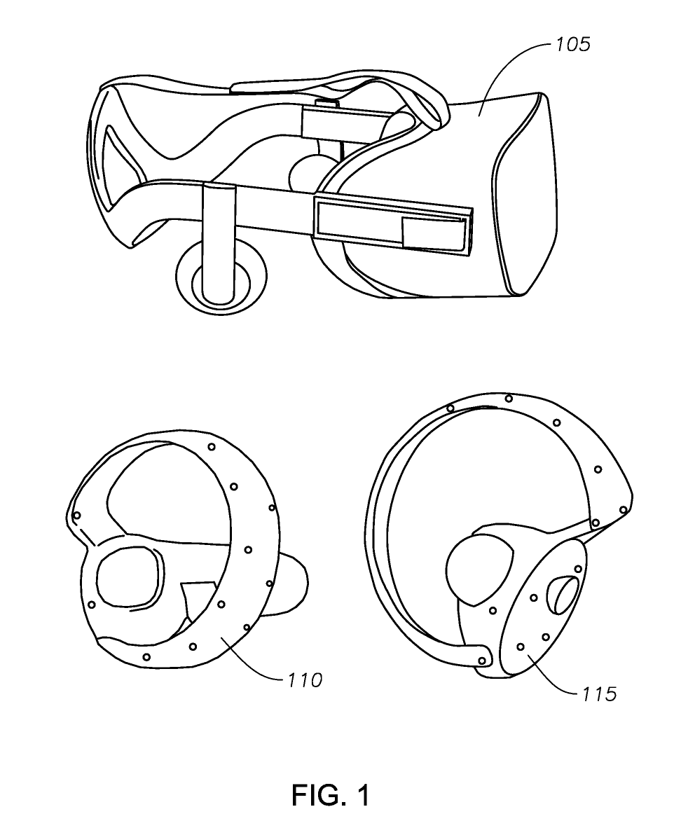

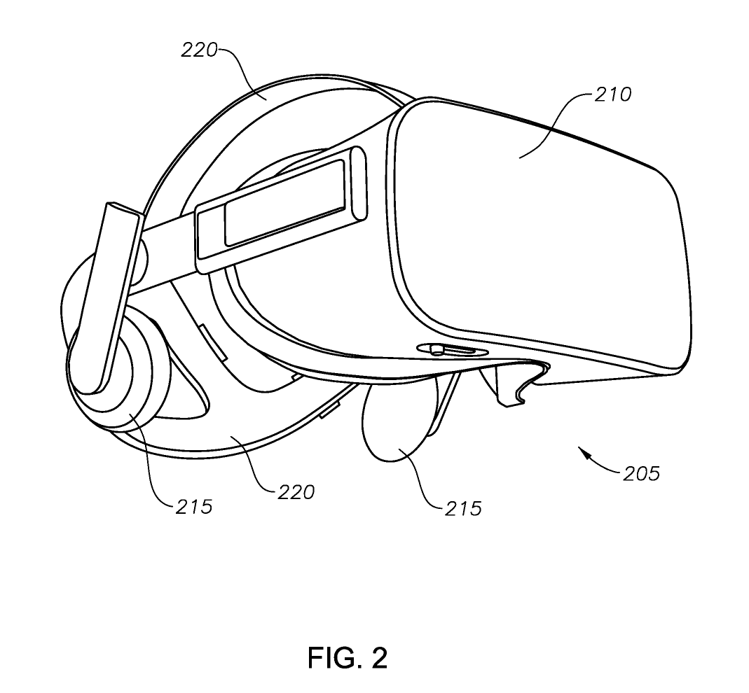

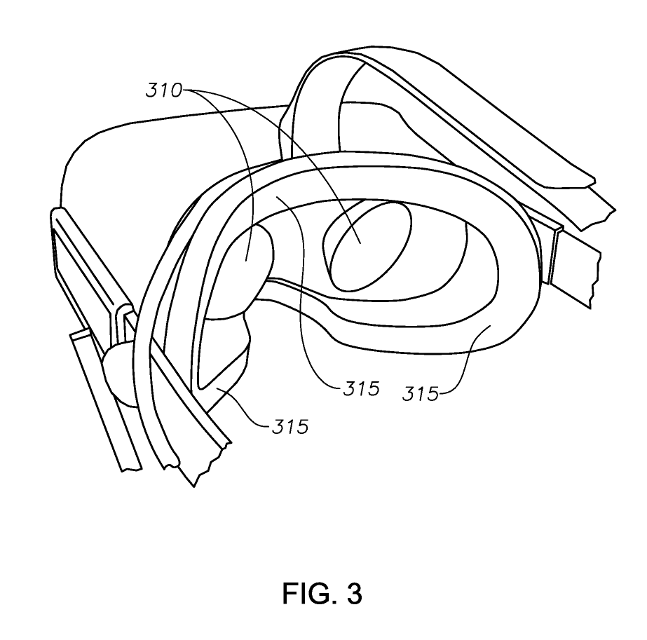

FIG. 1 illustrates a headset 105 and hand controllers 110, 115 according to one implementation. FIG. 2 is a perspective view of a headset 205. The electronics and optics are included in the housing 210. Also shown are the earpieces 215 and head strap 220. FIG. 3 illustrates a headset 305 providing a partial view of the optics 310 and a rigid structure 315 of the headset 305.

Some implementations of the present disclosure describe multi-level platform resting stands. In one implementation, the multi-level platform resting stand may include custom-shaped “cut aways” on the upper level which contour to the digital and/or computer-mediated reality equipment. These custom-shaped digital reality and/or computer-mediated reality equipment resting stands are tailored to fit and secure each piece of equipment, i.e., the hand controllers and the headset, for various brands of equipment. This is achieved by multi-level platforms, separated by spacers (e.g., vertical bars or other spacing mechanisms) in various dimensions and lengths. This is similar to a floating sandwich effect. In one implementation, the upper level platforms have cut away spaces which contour around particular perimeter points on the product, allowing the hand controllers to drop in and sink down securely to the lower level, or hover just above the lower layer, for support while the upper layer creates stability by contouring to a shape of the product(s) at contact points.

Headset Instability

Headset instability can be addressed in in a number of ways. In one implementation, headset instability may be addressed by resting the headset on an elevated platform. In another implementation, headset instability can be addressed using custom shaped openings for the front end of the headset. In yet another implementation, the headset resting stand can be a combination of the two designs, both with a support bar or bars and customized cut away shapes which allow the headset, glasses or Head Mounted Display device to “sink” into the elevated plate.

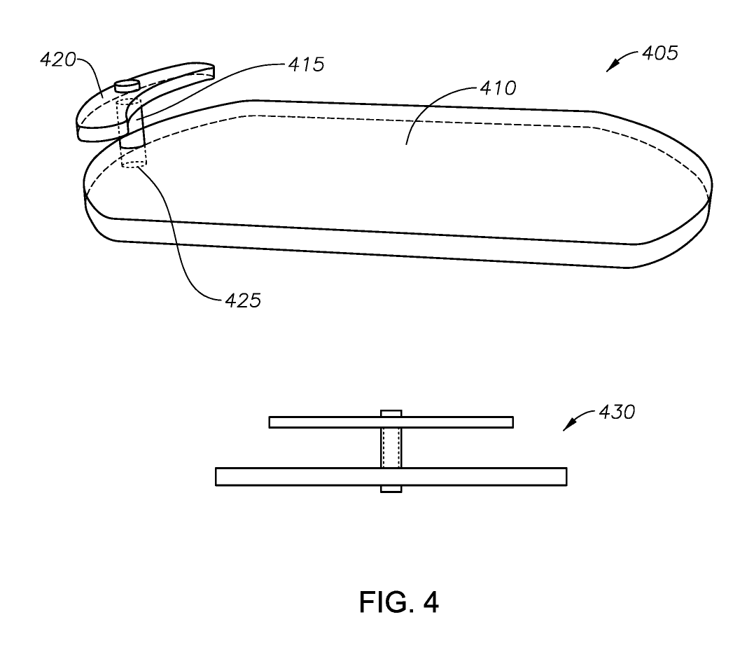

FIGS. 4-6 illustrate an implementation where the instability of the headset is addressed by resting the headset on the headset resting stand.

The headset resting stand shown in FIGS. 4-6 includes a bottom shelf, e.g., platform, and an elevated curved shelf, e.g., platform, which is supported by a vertical bar, e.g., spacer. The vertical bar is fixedly attached to the bottom shelf and the elevated, curved shelf. When the headset is not in use and stored on the headset resting stand, the vertical bar occupies the cut away space in the rigid structure reserved for a human nose when the headset is in use. The elevated, curved shelf contours and supports the interior upper rigid structure of the headset. The internal rigid structure on the upper brow side of the headset rests upon the elevated, curved shelf, e.g., a floating shelf. The floating shelf takes the majority of the front end weight of the headset and the back end of headset rests on the bottom platform.

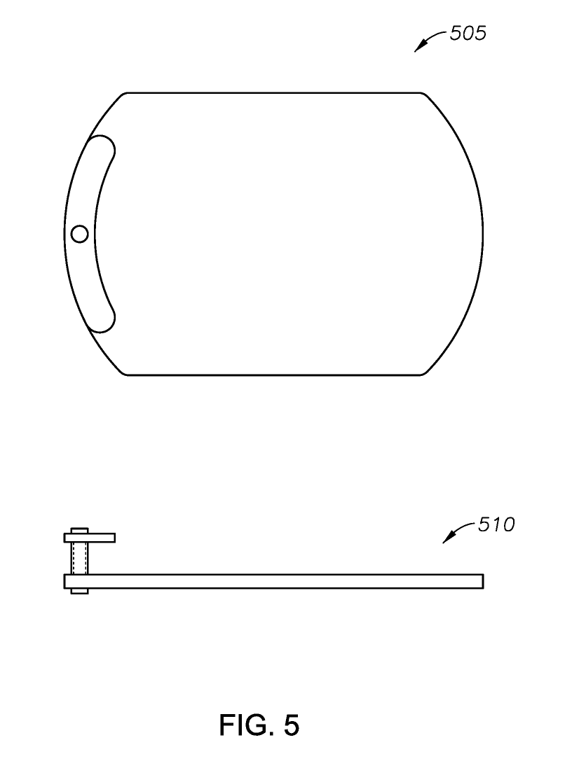

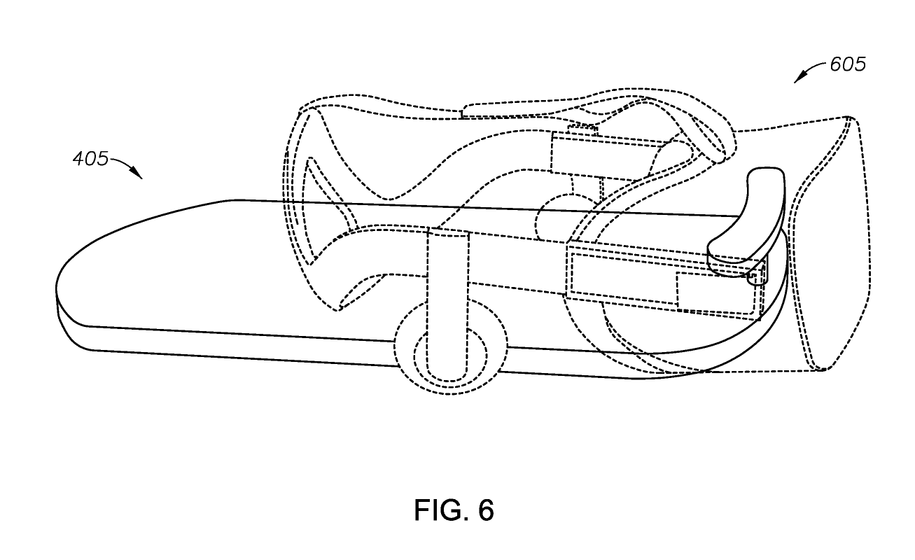

FIG. 4 illustrates a diagram of a resting stand 405 for a headset. The headset resting stand 405 includes a bottom platform 410, a vertical bar 415 and an elevated, curved platform 420. Although the figure shows only one vertical bar, it should be understood that the resting stand 405 may be configured with any number of vertical bars. Also shown is an opening 425 that allows for the attachment of the vertical bar 415 (which is already attached to elevated, curved platform 420 in this figure) to the bottom platform 410. FIG. 4 also shows a front view 430 of the headset resting stand 405. FIG. 5 illustrates a top view 505 and a side view 510 of headset resting stand 405. In one implementation, the dimensions of the headset of the present disclosure may be adjusted and/or changed to match different headset sizes. FIG. 6 illustrates a diagram of a headset being stored on a resting stand.

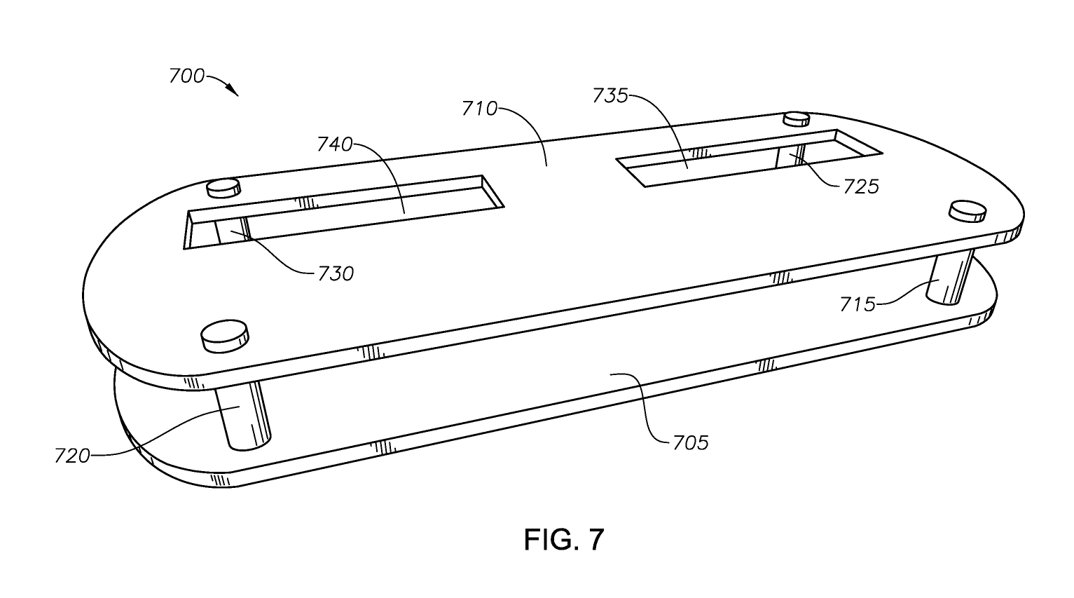

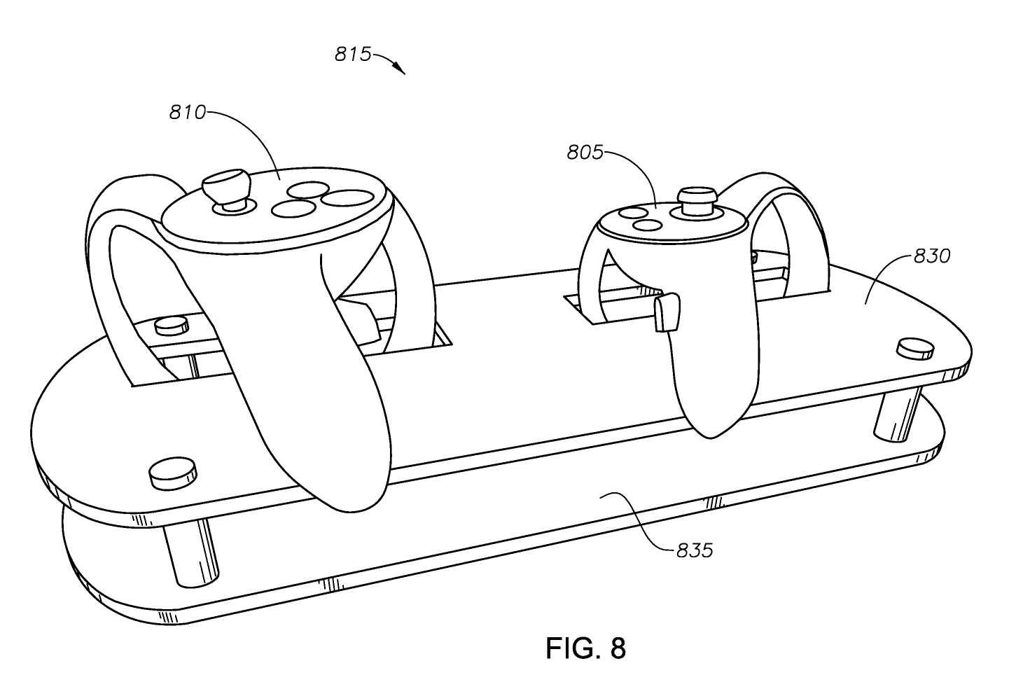

In another implementation, the headset resting stand may be configured such that the front end of the headset “sinks” into custom openings on a top horizontal layer, which is used instead of the elevated, curved shelf. The headset is secured by perimeter contact points of the upper (top horizontal) layer, and supported by the lower surface (the bottom platform) on which a bottom portion of the headset may rest. This implementation may or may not include a headset brow shelf (e.g., the elevated, curved or floating platform). Although this implementation is not shown in the figures, the implementation is similar to the hand controller resting stands shown in FIGS. 7 and 8 and described below where the hand controllers fit into custom openings in a top horizontal layer. In this implementation, instead of two openings, only one opening shaped to accommodate the headset is included in the top layer.

Hand Controller Instability

FIG. 7 illustrates a perspective view of one implementation of a hand controller resting stand, e.g., for hand controllers 110, 115. The hand controller resting stand design shown in FIG. 7 includes a bottom shelf 705 and an elevated shelf 710, which is supported by four vertical bars 715, 720, 725, 730. The elevated shelf includes openings 735, 740. The vertical bars 715, 720, 725, 730 are fixedly attached to the bottom shelf 705 and the elevated shelf 710. Although the figures show four vertical bars, it should be understood that hand controller resting stand may be configured with any number of vertical bars.

FIG. 8 illustrates an implementation showing two hand controllers 805, 810 being stored on a hand controller resting stand 815. The hand controller resting stand 815 includes a bottom shelf 835 and an elevated shelf 830. When the hand controllers 805, 810 are not in use and stored on the hand controller resting stand 815, a portion of each hand controller “sinks” into custom openings 820, 825 of the elevated shelf 830. The hand controllers are secured by perimeter contact points of the elevated shelf 830, and may or may not be in contact and supported by the bottom shelf 835. In one implementation, a bottom portion of the hand controller 805, 810 rests upon the bottom shelf 835. In another implementation, the hand controllers “sink” into the openings of the elevated shelf 830, but hover above the bottom shelf 835 thereby creating extra tension on the controllers around the cut away shapes or perimeter contact points of the elevated shelf 830, which produces a tight secure fit.

In one implementation, the hand controller resting stand may be configured to hold one hand controller each. These may be sold as a pair. In this implementation, the hand controller resting stand shown in FIGS. 7-8 may be split in two halves, with each being configured to hold one hand controller. In another implementation, the resting stand of FIGS. 7 and 8 may also be configured to have one opening shaped to hold a headset. The resting stand may also include implementations configured to hold a pair of hand controllers and a headset combined in a single resting stand.

Additional Enhancements

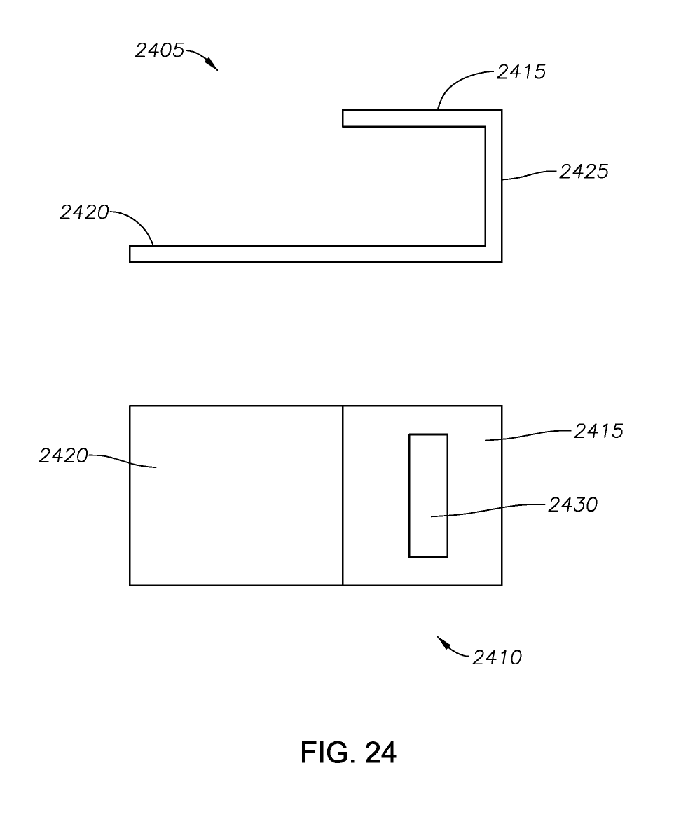

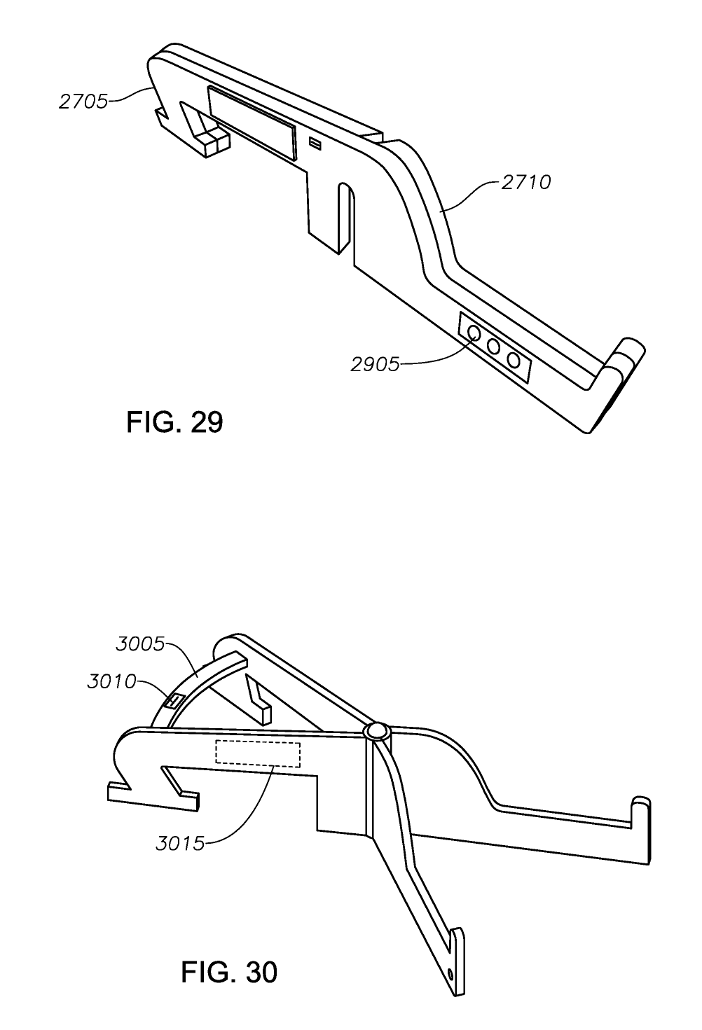

In one implementation, wireless charging capabilities can be built into the platforms of the resting stands so that the headset and hand controllers can charge when they are at rest. In another implementation, lighting, e.g., LED or equivalent, can be integrated into the resting stands. This implementation is described in more detail below with reference to FIG. 29. In another implementation, the platforms can be made visible in augmented reality so that controllers can be placed at rest while the headset is still worn by the user. In yet another implementation, all resting stands/platforms can be configured to be secured to a wall to allow vertical suspension of the headsets and hand controllers. In another implementation, the elevated platform/plate and the bottom platform/plate do not have metal spacer rods to create space between the plates, i.e., the space is created by using the thickness of the material to create a base by turning the material on its thickness side. In one implementation, a strip of material may be disposed between the elevated platform and the bottom platform. This configuration is described in more detail below with reference to FIG. 24. The height and length of the strip of material can vary. In another implementation, the shape of the material can vary from an X configuration to oval or circular.

In one implementation, the hand controller resting stands may be configured to provide specific support angles to keep portions of a hand controller level. In another implementation, plates are separated by spacers and include cut away spaces or shapes configured to provide a custom fit around a portion of a hand controller. In another implementation, a headset resting stand may be configured to include a cut away that provides an ability to avoid activation of a proximity sensor within a headset. In another implementation, specific cut away shapes are configured to fit a portion of a headset or handset controller for safety and security of the controller while at rest. In another implementation, portions of the digital and/or computer-mediated reality equipment can have the effect of hovering or floating in mid-air, e.g., partially hang out of a plate of the hand or headset controller stand. The above additional enhancements mentioned above can be applied to any of the implementations described herein and are described in more detail below.

Level and Hovering Design

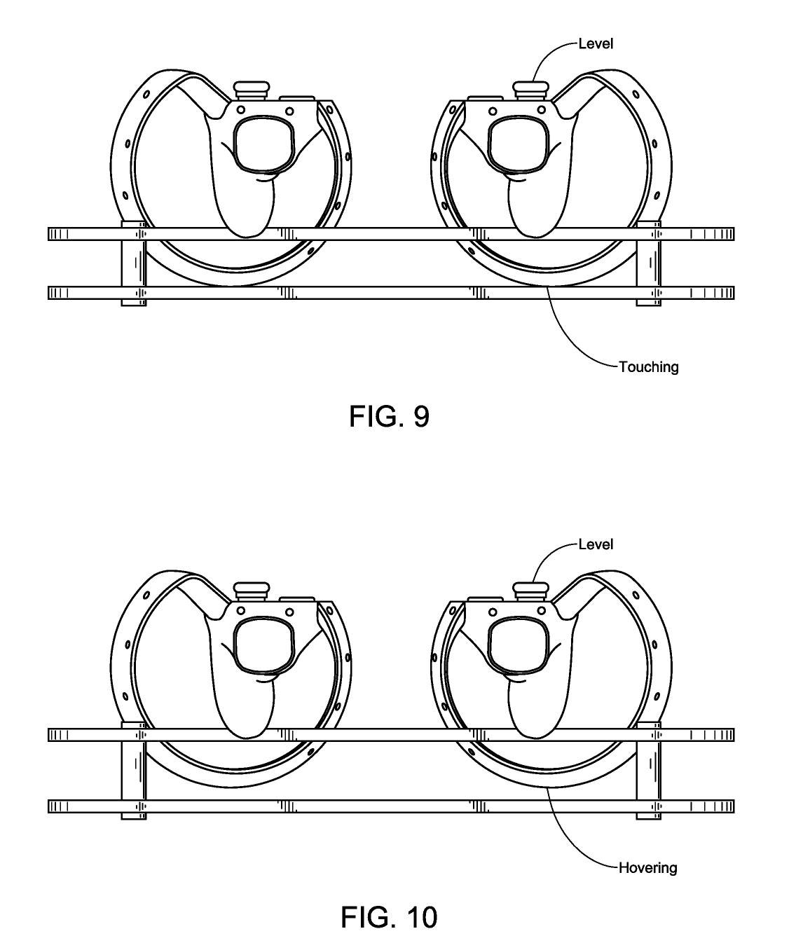

As described above, a hand controller stand may be multi-layered with two opposing plates separated by spacer rods. The top plate has cutaway spaces to accommodate digital reality and/or computer-mediated reality components and provide a customized, secure fit. In one implementation, the perimeter contacts of the hand controller resting stand are configured to allow the hand controllers to rest such that the top surfaces of the hand controllers are in a level configuration. The level configuration is shown in FIG. 9. In another implementation, the perimeter contact points of the hand controller stand are configured to allow the hand controllers to rest on a bottom plate or hover above the bottom plate of the hand controller resting stand. The hovering configuration is shown in FIG. 10.

Proximity Sensor

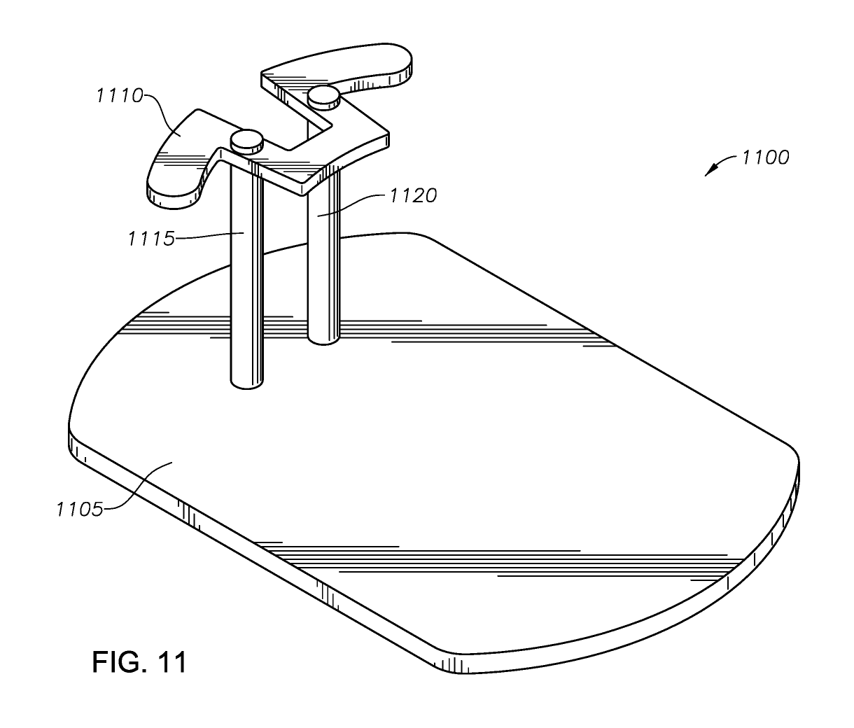

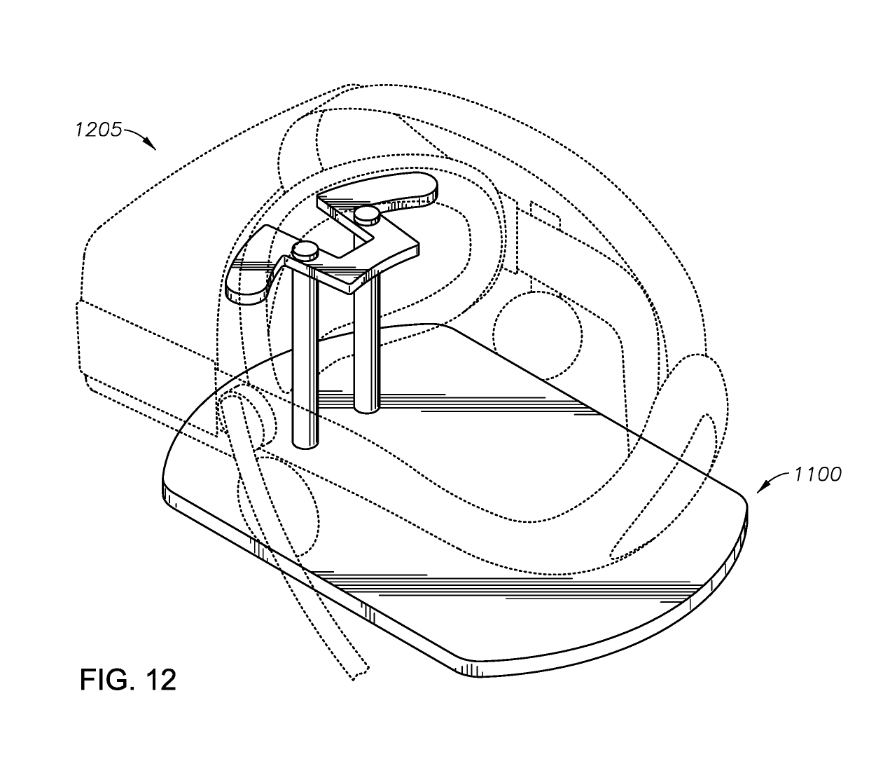

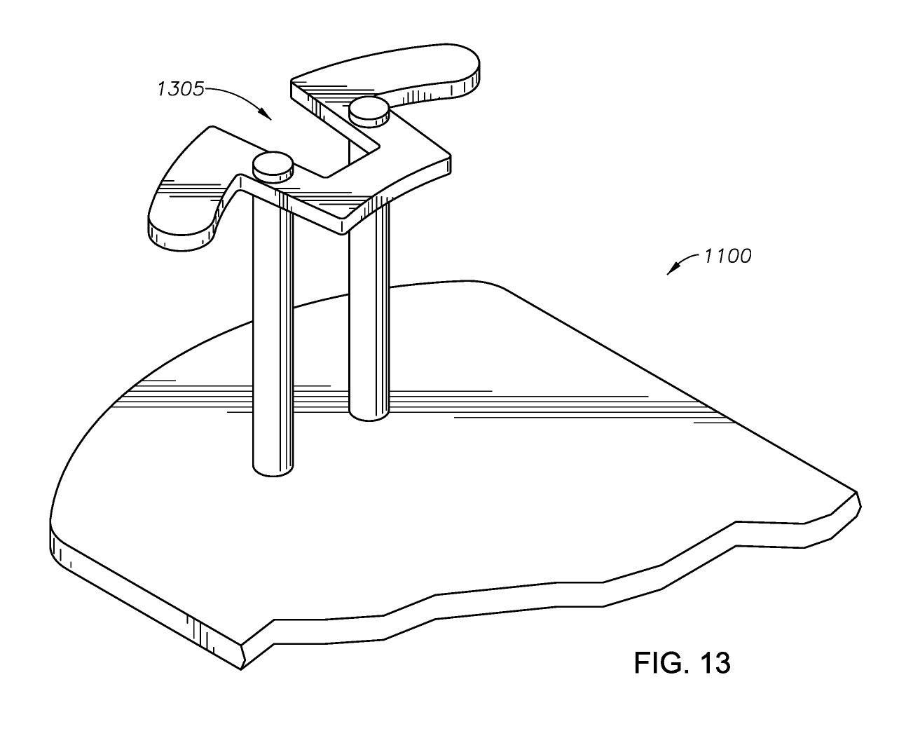

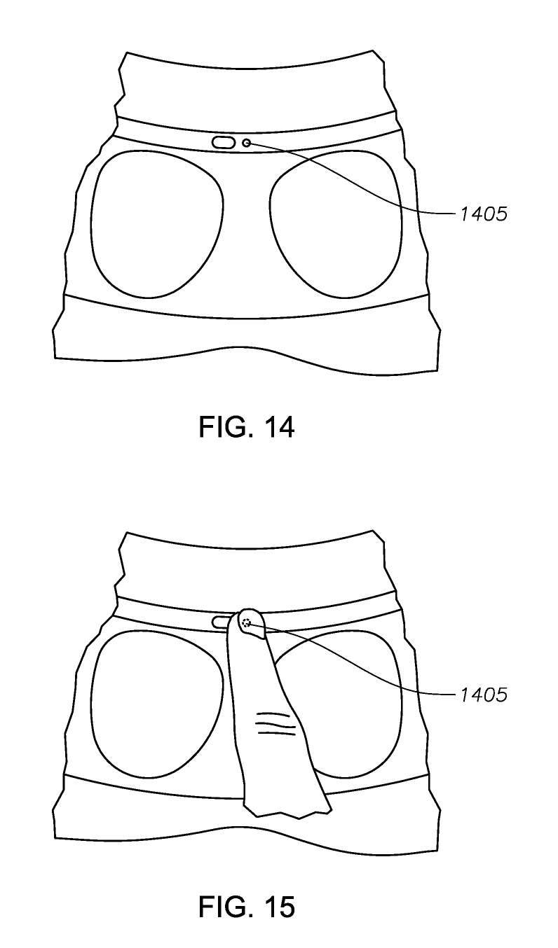

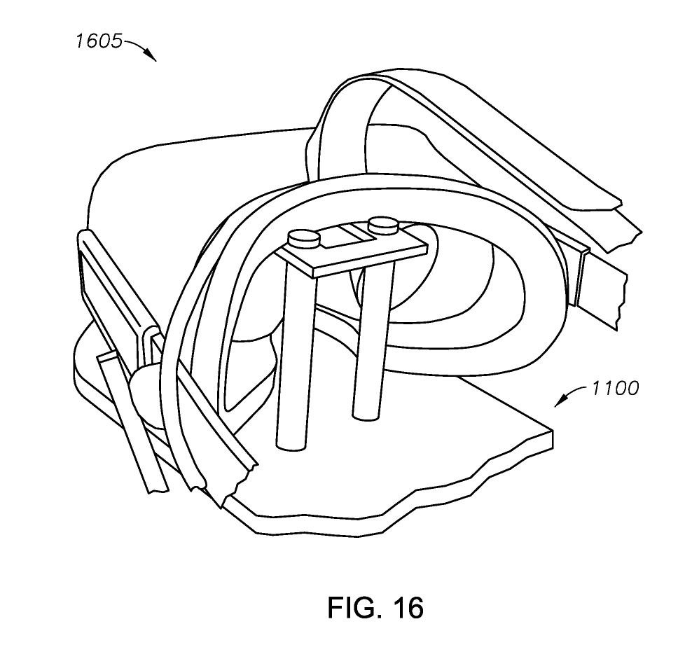

In one implementation, the headset resting stand may be shaped or configured to avoid activating a proximity sensor of the headset. This implementation of the headset resting stand is shown in FIG. 11. The headset resting stand 1100 includes a first platform 1105, a second platform 1110, and two spacers/columns 1115, 1120. FIG. 12, shows a headset 1205 resting on the headset resting stand 1100. FIG. 13 shows a top portion of the headset resting stand 1100 having a cut away portion/space 1305. This cutaway portion 1305 is configured to prevent the activation of a proximity sensor of the headset. FIG. 14 shows a proximity sensor 1405 of a headset. In this view, the proximity sensor 1405 is deactivated because the sensor does not detect an object. FIG. 15 shows that the proximity sensor 1405 is in an activated state due to the presence of an object. The cut away portion 1305 of the headset stand provides an open space that keeps the proximity sensor in a deactivated state when the headset is stored on the headset resting stand 1100. FIG. 16 shows a headset 1605 being stored on the headset resting stand 1100, which is configured to keep the headset in a deactivated state. Various additional enhancements described above with reference to the spacer disposed between the top and bottom platforms and the number of columns are also applicable with this headset resting stand implementation.

Hand Controller Stand—Level Controller

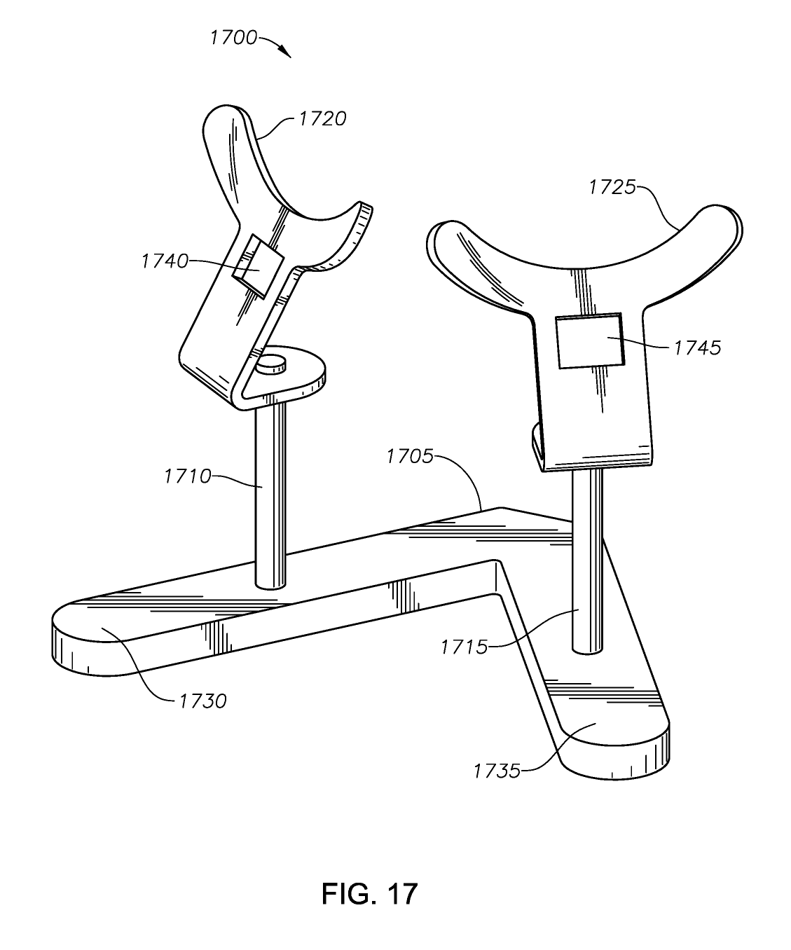

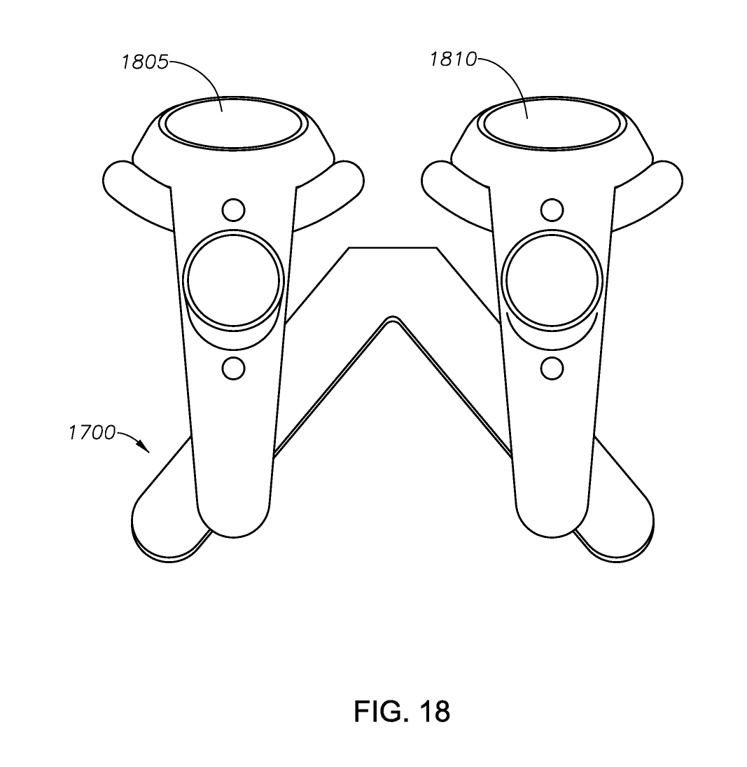

FIG. 17 shows a hand controller resting stand 1700 according to one implementation. The hand controller resting stand 1700 includes a v-shaped base 1705, a first column 1710, a second column 1715, a first stand body 1720, a second stand body 1725 and cut aways 1740, 1745. A first end of the first column 1710 is coupled to a first arm 1730 of the v-shaped base. In one implementation, the first end of the first column 1710 is the bottom/lower end. The first stand body 1720 is coupled to a second end of the first column 1710. In one implementation, the second end of the first column 1710 is the top/upper end. A first end of the second column 1715 is coupled to a second arm 1735 of the v-shaped base 1705. In one implementation, the first end of the second column 1715 is the bottom/lower end. The second stand body 1725 is coupled to a second end of the second column 1715. In one implementation, the second end of the second column 1715 is the top/upper end. FIG. 18 shows a hand controller stand 1700 having two hand controllers 1805, 1810 stored thereupon.

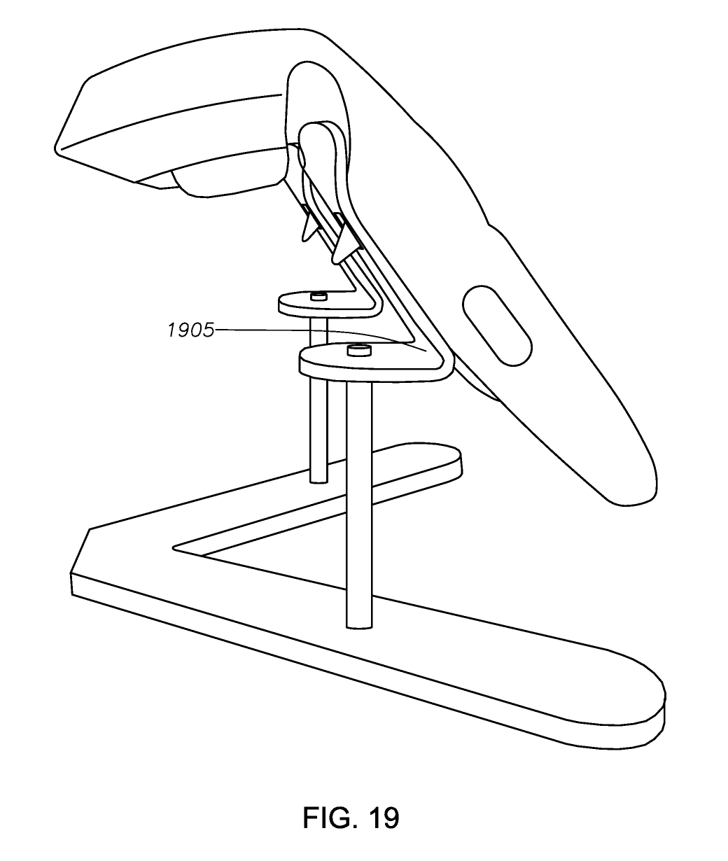

In one implementation, an angle of the stand bodies 1720, 1725 are configured such that the hand controllers are level when stored on their respective holder. This angle 1905 is shown in FIG. 19. In addition, in one implementation, the spine of the stand body is shaped to contour and support a hand portion of each hand controller in addition to providing angle 1905 to keep the hand controller level.

Hand Controller Stand—Cut Away for Buttons/Triggers

In one implementation, as shown in FIG. 17, the stand bodies include a cut away, e.g., cut aways 1740, 1745. As shown in FIG. 20, the purpose of cut away 1740, 1745 is to allow controller buttons/triggers 2005 to protrude through the stand body for extra security. The cut aways 1740, 1745 also allow a body of the hand controller to rest against and follow the angle of the stand body for a close and secure fit. This configuration allows a top portion of the hand controller to rest in a horizontal position on the hand set controller resting stand.

Headset Stand—Cut Away for Bottom Portion(s) of Headset

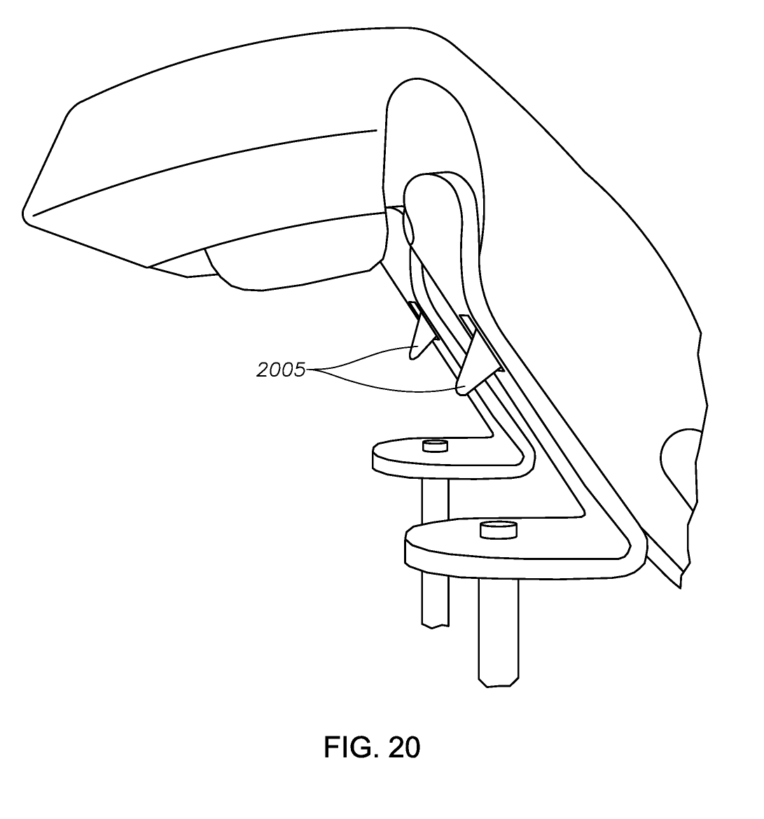

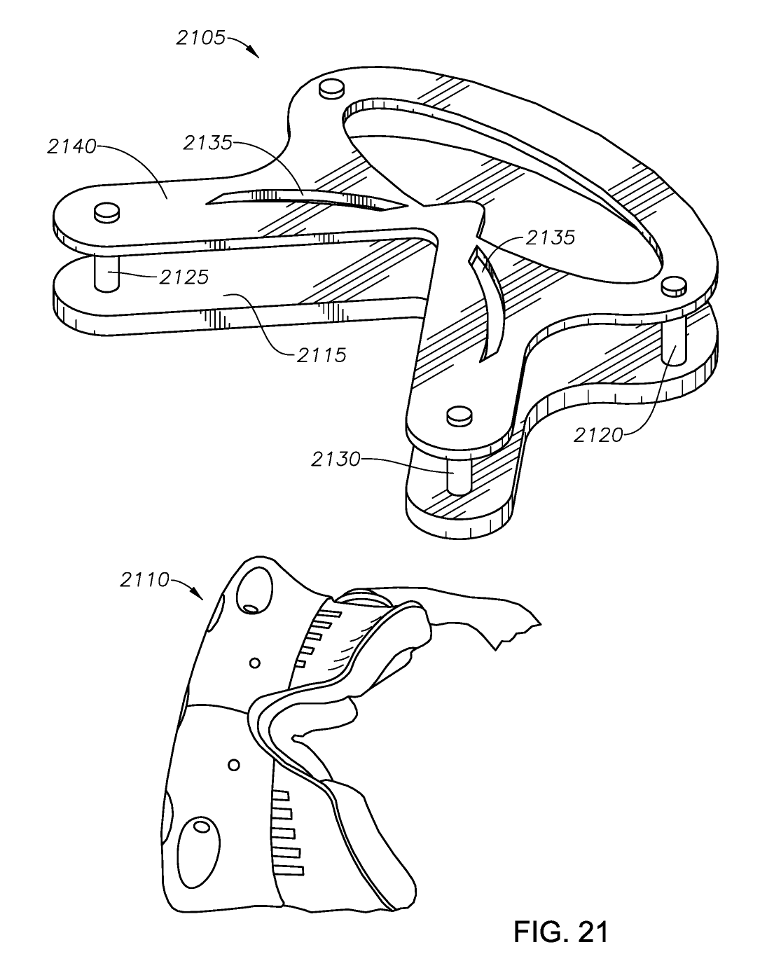

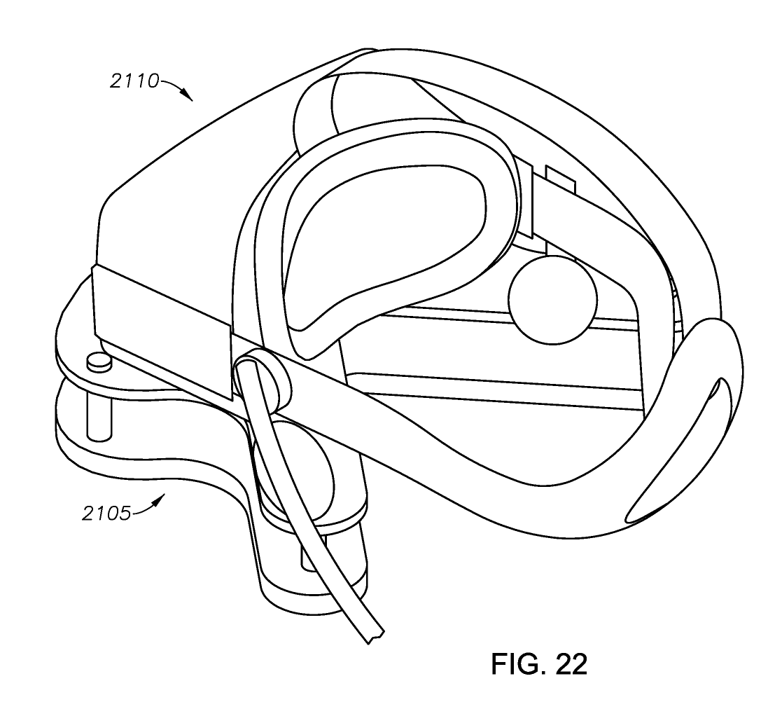

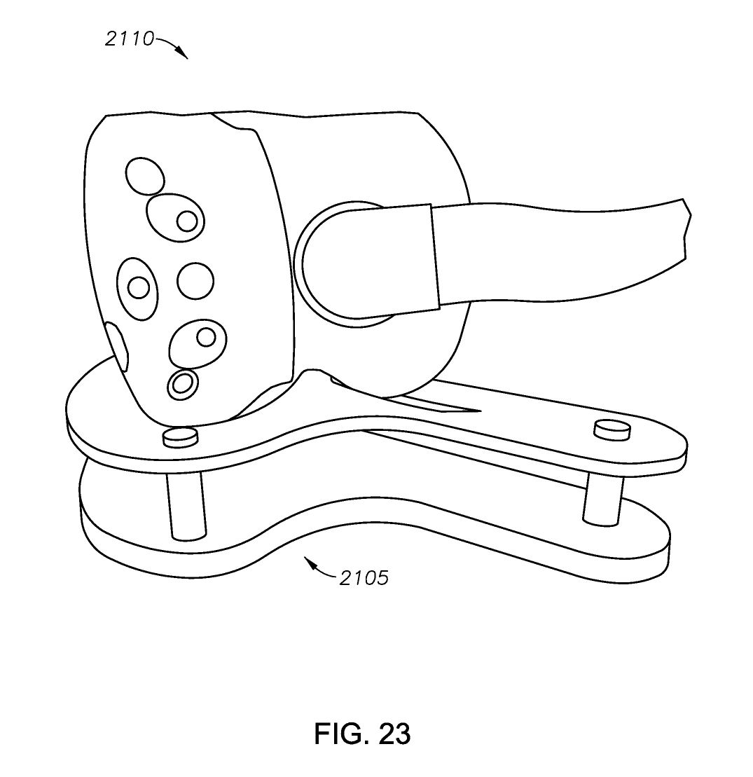

FIG. 21 shows perspective views of a resting stand 2105 for a headset 2110. The headset resting stand 2105 includes a bottom shelf 2115, four vertical bars (only vertical bars 2120, 2125, 2130 are visible in FIG. 21) and an elevated shelf 2140 having cut outs 2135. In one implementation, the cut outs 2135 are precise and follow a mold and design of the bottom contours of the headset. FIG. 22 and FIG. 23 show additional views of the headset 2110 resting on the resting stand 2105.

Single Piece Configuration

FIG. 24 shows a side view 2405 and a top view 2410 of a resting stand shaped from a single strip of material to accommodate digital reality and/or computer-mediated reality equipment. In this implementation, the elevated plate 2415 and lower plate 2420 do not have metal spacer rods to create space between the plates. In this implementation, the space is created by shaping the material to include a spacer portion 2425. A space 2430 is shaped to accommodate the digital reality and/or computer-mediated reality equipment. The height and length of the strip of material can vary.

Floating configuration for controllers

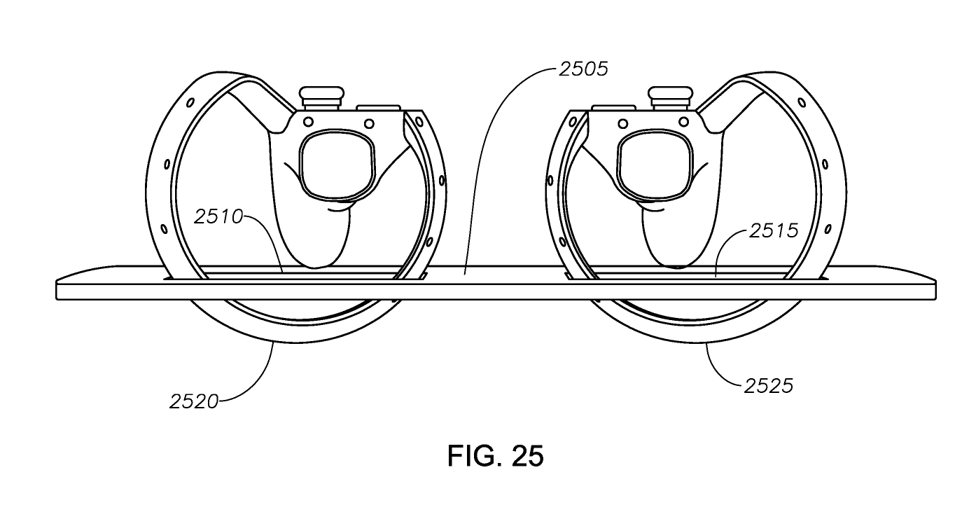

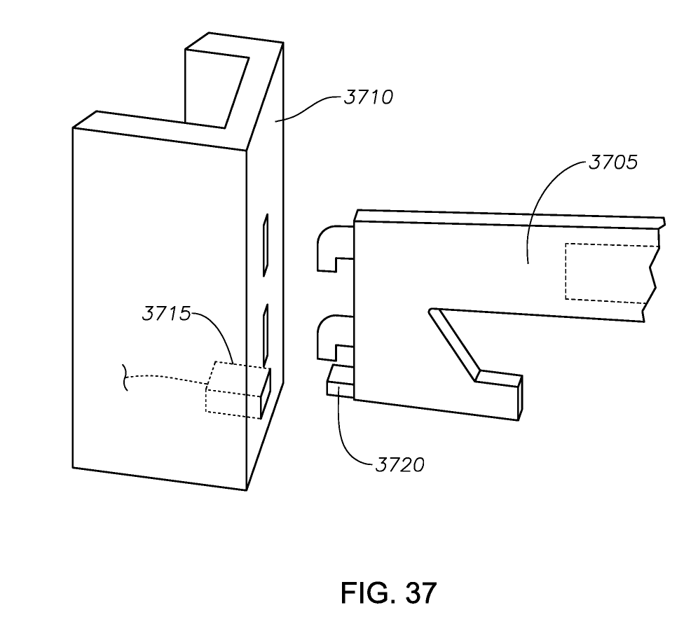

FIG. 25 shows a hand controller resting stand 2505 that includes a plate having cut aways 2510, 2515 shaped to accommodate a hand controller 2520, 2525 in a floating or hovering configuration according to one implementation. In one implementation, this plate may be attached to a wall, a corner, or some other vertical surface(s). This configuration is described in more detail below with reference to FIG. 37.

X-shaped Resting Stand Configurations

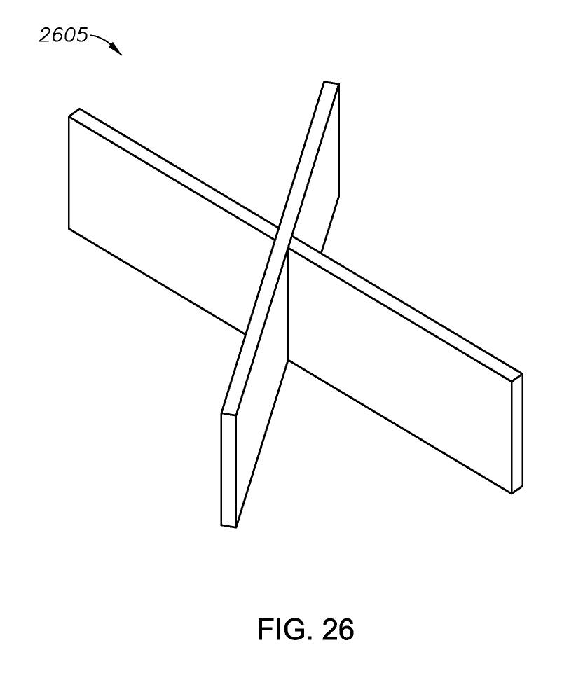

FIG. 26 shows one implementation of a base of a headset resting stand in the shape of an X configuration. In one implementation, an elevated plate (not shown) may rest upon an x-shaped base 2605, much like a glass coffee table top rests upon a support frame. The elevated plate can be fastened with screws, magnets, or adhesive.

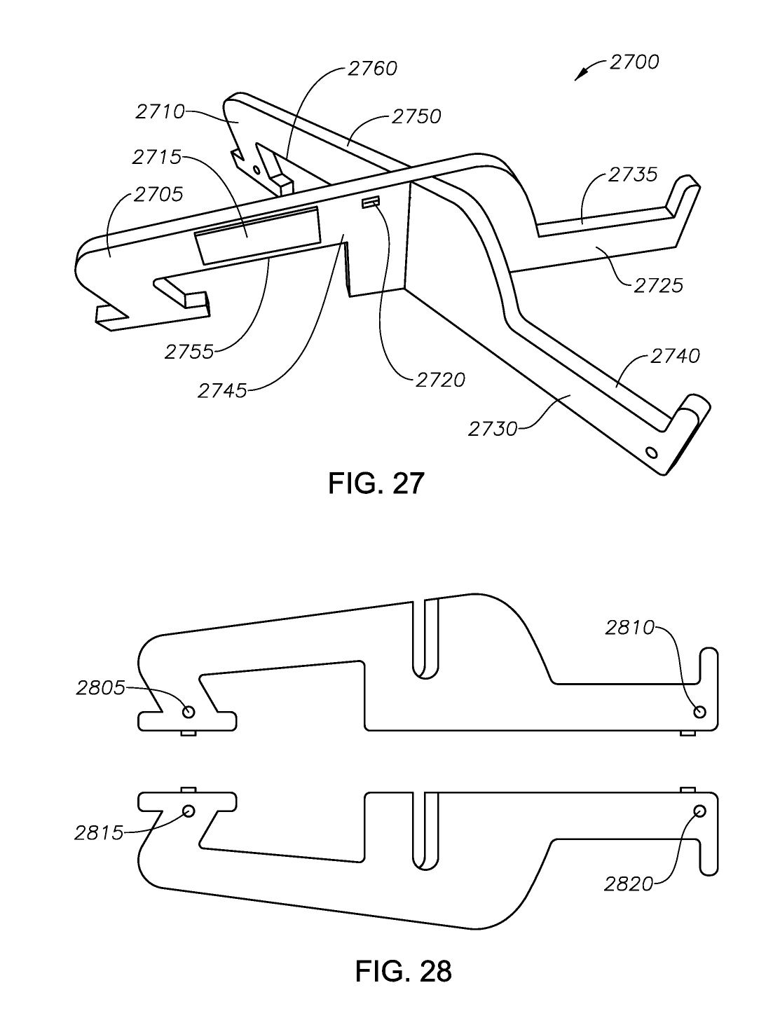

FIGS. 27-36 illustrate various configurations for an X-shaped resting stand. FIG. 27 illustrates an X-shaped resting stand 2700 according to one implementation. The X-shaped stand includes two pieces of material 2705, 2710. The material may be acrylic, aluminum, wood, plastic, or other material. The two pieces of material 2705, 2710 are shaped to interlock to secure the two pieces of material together to form an X shape. When the X-shaped resting stand is expanded and interlocked, portions of the X-shaped resting stand include contours to protect and secure a headset or other equipment.

The X-shaped resting stand 2700 may have an onboard battery 2715. The onboard battery may be within one of the arms, fastened to the arm/arms, or within a “cross brace” (described below). This battery 2715 may be used to charge various headsets while resting on the X-shaped resting stand 2700. A charging port 2720 for charging a headset can also be included in X-shaped resting stand. The charging port 2720 can be used to charge both the battery 2715 and a headset simultaneously.

The shape and contours of the top side 2735, 2740 of a front portion 2725, 2730 may vary a based on the digital reality and/or computer-mediated reality equipment. The X-shaped resting stand can be shaped to correspond to specific headsets or may be configured to be universal such that a variety of equipment may be stored using a single design. A bottom side 2755, 2760 of a rear portion 2745, 2750 of the X-shaped resting stand can be configured for other functional uses such as a headset cord winder or storage.

In one implementation, colors of the X-shaped stand may vary if made using acrylic. In one implementation, fluorescent acrylic colors may be used. Examples of fluorescent acrylic colors may include, but are not limited to, acid green, helios yellow, lava orange, mars red and Neptune blue. In one implementation, the fluorescent acrylic colors of the X-shaped stand have a glowing effect.

FIG. 28 illustrates the X-shaped stand in a disengaged state. The two pieces of material 2705, 2710, when disengaged, may be fastened together in a flat (or collapsed) configuration using elements 2805, 2810, 2815, 2820. Elements 2805, 2810, 2815, 2820 can be integrated magnets, micro Velcro or other material or means to couple the two pieces of material 2705, 2710 together when the X-shaped resting stand 2700 is not in use and expanded into the X shape.

FIG. 29 illustrates a fastened (or collapsed) configuration of the two pieces of material 2705, 2710. In one implementation, lighting, e.g., lighting 2905, may be included on various portions of the X-shaped stand.

FIG. 30 illustrates a cross brace 3005 configured to attach to a rear portion of the X-shaped resting stand. An external battery/power and/or USB port 3010 may be secured to or within the cross brace 3005. The cross brace 3005 is designed to connect to the X-shaped resting stand. In the interlocking configuration, the cross brace 3005 attaches to the rear portion of each of the two pieces of material 2705, 2710. In a hinged configuration, described below, the cross brace 3005 attaches to the rear legs. The cross brace 3005 is useful in situations where the USB or headset charging interface is centered and is not directly near the front portion or the front legs of the X-shaped resting stand. The cross brace 3005 provides more versatile and flexible centralized access to the electronic ports of a headset. In one implementation, port 3010 is electrically coupled to the battery 3015 when attached to the X-shaped stand.

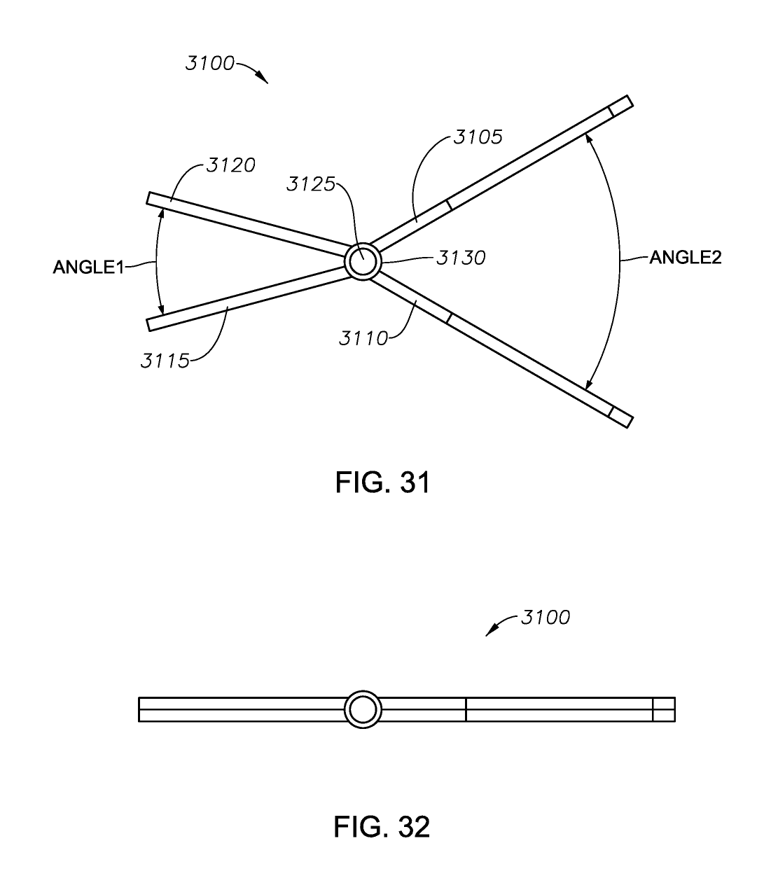

FIG. 31 illustrates a hinged X configuration of a resting stand 3100. Legs 3105, 3110, 3115, 3120 are coupled together via hinge 3130. In one implementation, the X-shaped stand can fold flat (in a closed state) for portability and expand into an X shape (an open state) using the hinge. FIG. 32 illustrates the hinged X configuration in a flat position. The hinged X configuration may be activated by utilizing a push button swivel mechanism 3125 to fold and expand the X-shaped stand. This push button swivel mechanism 3125 can be spring loaded or manual. In one implementation, the front legs 3105, 3110 and rear legs 3115, 3120 of the X-shaped stand may be adjusted. In another implementation, the front legs 3105, 3110 and rear legs 3115, 3120 of the X-shaped stand may not be symmetrical. In other words, the front legs and/or rear legs of the X-shaped resting stand may have a narrow stance (Angle 1) or wider stance (Angle 2). In one implementation, the front legs and rear legs may be expanded to different widths independent of one another. In one implementation, an ideal expanded width of the legs of the X-shaped resting stand can be locked-in so the stand expands into the same position with every use and at the push of a button.

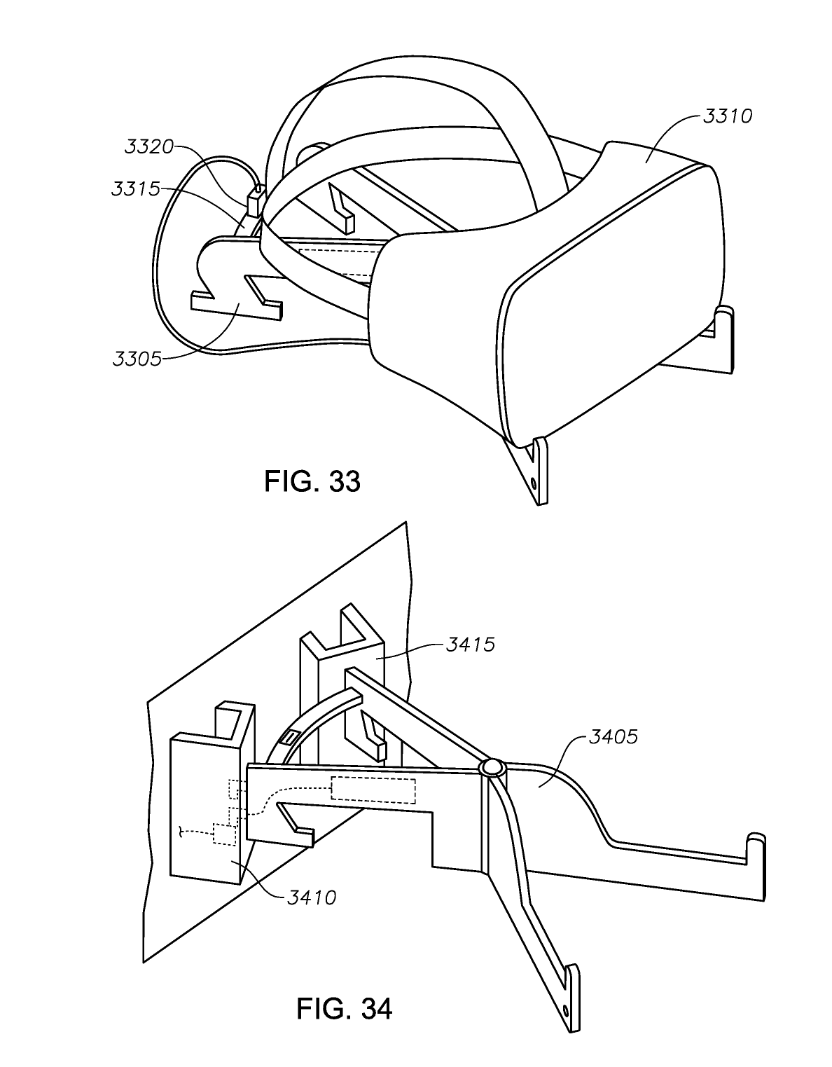

FIG. 33 illustrates a headset 3310 resting in an X-shaped resting stand 3305. In this implementation, the X-shaped resting stand 3305 includes a cross brace 3315. The headset 3310 can be charged by coupling the headset 3310 to an external battery/power and/or USB port 3320 of the cross brace 3315.

FIG. 34 illustrates a wall-mounted configuration of the X-shaped resting stand. In this configuration, the X-shaped resting stand 3405 is coupled to wall mounting elements 3410, 3415.

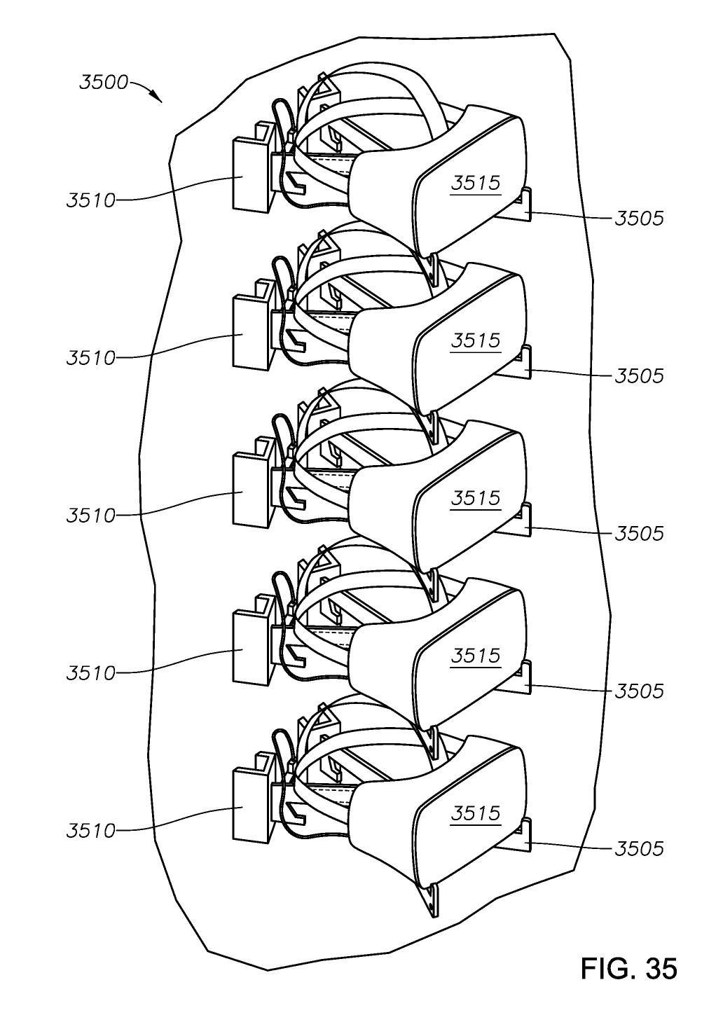

In one implementation, the X-shaped resting stand can be coupled to a vertical railing wall system, much like the interface used for modular shelving systems. The wall-mounted interface can be designed for one or more headsets. FIG. 35 illustrates a wall-mounted configuration 3500 for a plurality of X-shaped stands. The X-shaped stands 3505 are coupled to a vertical railing wall system 3510. The plurality of X-shaped stands can be used to store and/or charge one or more headsets 3515.

In one implementation, one or more X-shaped resting stands can be coupled to charging slotted wall upright strips. The slotted wall upright strips include a USB interface so that power can be transferred from the slotted wall upright strips to a battery of the X-shaped resting stand and/or a headset stored on the X-shaped resting stand.

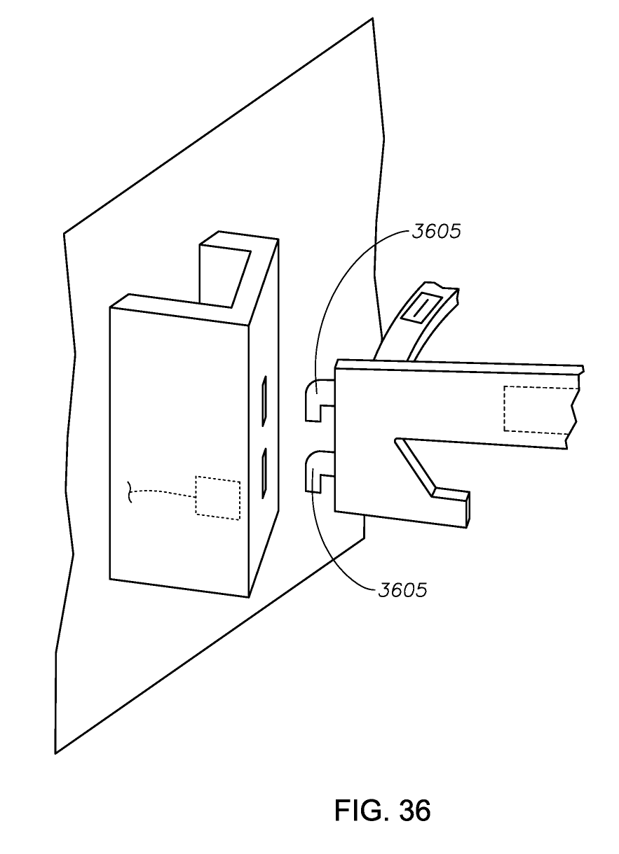

FIG. 36 illustrates an interface for coupling an X-shaped resting stand to a wall. In one implementation, the X-shaped resting stand has an interface 3605, similar to a shelving system. This interface 3605 allows the rear legs or rear portions of the X-shaped resting stand to be coupled to or inserted into a vertical railing system for storage on a wall. Although a hook shaped interface is shown in FIG. 36, any interface that allows the X-shaped resting stand to be coupled to the wall can be used.

FIG. 37 illustrates power interfaces for the X-shaped resting stand 3705 and the wall railing system 3710. In one implementation, charging of the battery and/or headset is provided via a connection to a power interface 3715 of the wall railing system 3710. In one implementation, a base interface portion 3720 of the X-shaped resting stand 3705 makes magnetic contact with the power interface 3715. The magnetic contact of interfaces 3705, 3715 provides an electrical connection between the X-shaped resting stand and the wall railings. The electrical connection can be used to charge a battery stored on or within the X-shaped resting stand and/or a headset stored on the X-shaped resting stand. Charging of the headset may take place while the X-shaped resting stand is on a surface, e.g., a desk, a tabletop or other surface, or while the X-shaped resting stand is fastened to the vertical wall system, thereby charging both the onboard battery and the headset simultaneously.

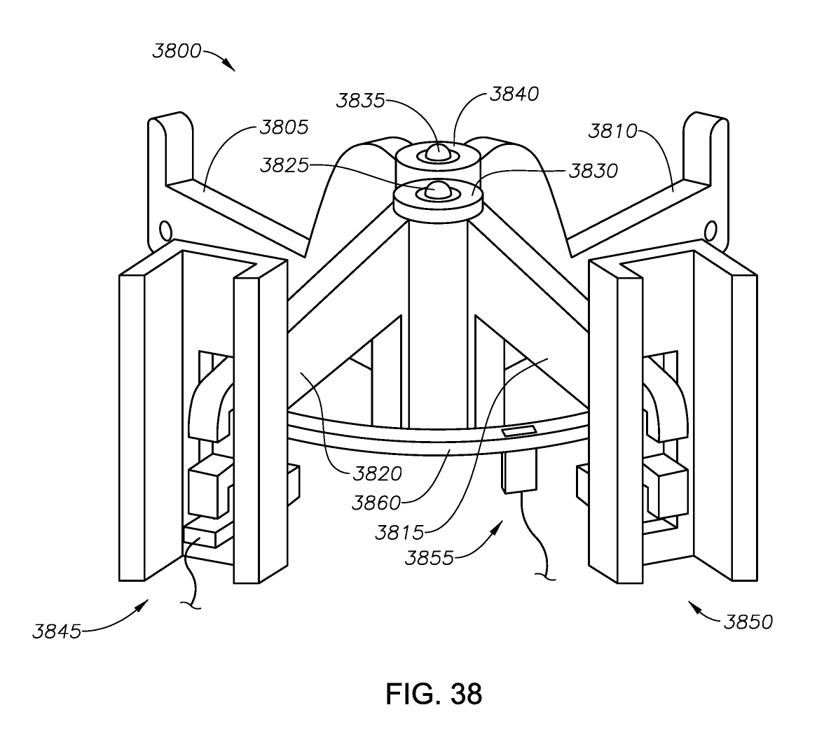

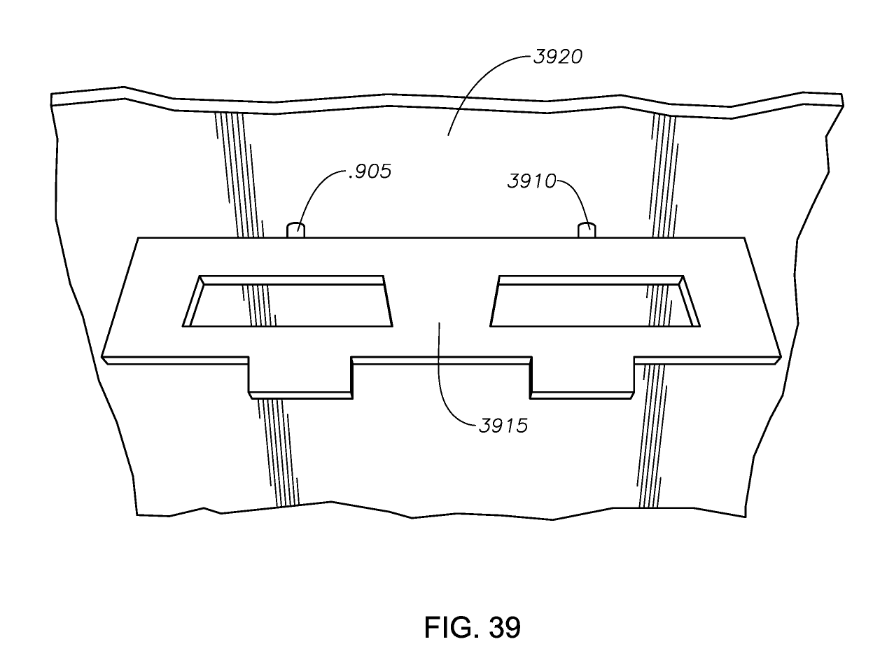

FIG. 38 illustrates a double hinged X configuration of a resting stand 3800. Legs 3805, 3810 are coupled together via hinge 3840. Legs 3815, 3820 are coupled together via hinge 3830. In one implementation, the X-shaped stand can fold flat (in a closed state) for portability and expand into an X shape (an open state) using the hinges 3830, 3840. The hinged X configuration may be activated by utilizing a push button swivel mechanism 3825, 3835 to fold and expand the X-shaped stand. This push button swivel mechanism 3825, 3835 can be spring loaded or manual. The legs 3805, 3810, 3815, 3820 may be adjusted to have a wider stance or a narrow stance and/or locked-in as described above with respect to FIG. 31 and FIG. 32. FIG. 38 also illustrates a vertical wall railing system 3850, power interfaces 3845, 3855, and cross bar 3860.

In one implementation, referring to FIG. 31 and FIG. 38, hinges 3130, 3830, 3840 can accommodate one or more rechargeable or disposable batteries within a cavity of the hinge to charge a headset. In another implementation, the entire X-shaped stand is configured to magnetically charge the headset.

Floating Wall Bolt Systems with Male/Female Attachment Interface

FIG. 39 illustrates a floating bolt configuration for coupling a resting stand to a wall. Additional wall system designs can include various headset, hand controller, and camera configurations where the stands are fastened to the wall with floating bolts, e.g., bolts 3905, 3910. Bolts 3905, 3910 minimize an amount of material needed to secure the products due to extra space between the resting stand 3915 and the wall 3920 provided by the wall bolts.

Materials

The resting stands can be manufactured in a variety of materials including, but not limited to, aluminum, acrylic, wood, plastic, other metals, etc. The same applies to the vertical supporting uprights which create the space between horizontal layers.

Although the figures show a particular headset and particular hand controllers, it should be noted that the resting stands of the present disclosure can be configured to work with any type of digital reality and/or computer-mediated reality (e.g., VR, AR, MR or holographic) equipment.

In addition, it should be understood that the digital reality and/or computer-mediated reality equipment described herein may include hand held or hand attached devices, gloves, controllers or tools specifically used to navigate operating systems and software within digital reality and/or computer-mediated reality environments, and also include head set goggles, displays, head mounted displays (HMD), and/or holographic devices.

It is further to be understood that various implementations described herein for digital reality and/or computer-mediated reality hand controllers are universal in purpose and application. The aforementioned devices don't exist only for games, but rather as universal essential tools needed for navigation within various digital environments and realities of operating systems, software programs and/or software applications. The operating systems may be within an enterprise setting or personal setting, similar to the way tools, such as the keyboard and the mouse are presently required for interacting and controlling 2D computer systems and applications.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A virtual reality (VR) equipment resting stand, comprising:
a first platform configured to support at least a portion of the VR equipment;
a second platform; and
at least one vertical spacer coupling the first platform and the second platform.

2. The VR equipment resting stand of claim 1, wherein a first end of the vertical spacer is coupled to the first platform and a second end of the vertical spacer is coupled to the second platform.

3. The VR equipment resting stand of claim 1, wherein the first platform includes at least one opening to support at least the portion of the VR equipment.

4. The VR equipment resting stand of claim 3, wherein the first platform, the second platform, and the vertical spacer are comprised of a single piece of continuous material.

5. The VR equipment of claim 4, wherein the single piece of continuous material is molded or bent to form the first platform, the second platform and the vertical spacer.

6. The VR equipment resting stand of claim 1, wherein the first platform includes a cut away configured to keep a proximity sensor of the VR equipment in a deactivated state.

7. The VR equipment resting stand of claim 1, wherein the VR equipment resting stand is configured to hold at least the portion of the VR equipment such that the VR equipment is level.

8. The VR equipment resting stand of claim 1, wherein the first platform is configured to hold at least the portion of the VR equipment such that the VR equipment is hovering above the second platform.

9. The VR equipment resting stand of claim 1, wherein the first platform is configured to hold at least the portion of the VR equipment such that a second portion of the VR equipment is touching the second platform.

10. The VR equipment resting stand of claim 1, wherein the first platform includes at least one cut away to accommodate embedded sensors, buttons and/or triggers of the VR equipment.

11. A virtual reality (VR) equipment resting stand, comprising:
a first piece having a first front portion and a first rear portion; and
a second piece having a second front portion and a second rear portion, wherein the first piece and the second piece are shaped to interlock and form an X-shape;
wherein the first front portion and the second front portion are shaped to support at least a portion of the VR equipment.

12. The VR equipment resting stand of claim 11, wherein the VR equipment resting stand includes a battery.

13. The VR equipment resting stand of claim 11, wherein the VR equipment resting stand includes a charging port.

14. The VR equipment resting stand of claim 13, wherein the charging port charges a battery and/or VR equipment.

15. The VR equipment resting stand of claim 11, wherein in a disengaged state, the first piece and the second piece are fastened together in a flat configuration.

16. The VR equipment resting stand of claim 15, wherein the first piece and the second piece are fastened together using magnets.

17. The VR equipment resting stand of claim 11, wherein the VR equipment resting stand includes lighting.

18. A virtual reality (VR) equipment resting stand, comprising:
a front portion; and
a rear portion, wherein the front portion and the rear portion are coupled together via a hinge;
wherein the front portion is shaped to support at least a portion of the VR equipment.

19. The VR equipment resting stand of claim 18, wherein the VR equipment resting stand is configured to have a flat configuration in a closed state and an X-shaped configuration in an open state.

20. The VR equipment resting stand of claim 19, wherein at least one of the open state and the closed is activated using a push button swivel mechanism.
